(19) United States
(12) Patent Application Publication
(10) Pub. No.: US 2022/0105370 A1
(43) Pub. Date: Apr. 7, 2022

(54) METHODS AND COMPOSITIONS FOR IMPROVING FABRIC BASED ENTRAPMENT OF AQUEOUS AEROSOL ASSOCIATED NANOPARTICLES

(71) Applicant: DetraPel, Inc., Framingham, MA (US)

(72) Inventors: Tarek Tabbara, Holliston, MA (US); David Zamarin, Jamison, PA (US); Casey Wetzel, San Diego, CA (US); Juan Jarufe, North Olmsted, OH (US); Melissa Jarufe, North Olmsted, OH (US)

(73) Assignee: DetraPel, Inc.

(21) Appl. No.: 17/495,581

(22) Filed: Oct. 6, 2021

Related U.S. Application Data
(60) Provisional application No. 63/088,740, filed on Oct. 7, 2020.

(51) Int. Cl. A62B 23/00; C08G 63/06; D06B 3/10

(52) U.S. Cl. CPC A62B 23/00; B82Y 40/00; D06B 3/10; C08G 63/06

(57) ABSTRACT

The present invention relates generally to methods of using stable aqueously dispersed superhydrophobic compositions to provide superhydrophobic treatments on a range of porous and semi-porous target materials and surfaces to enhance the filtration properties of the materials and surfaces. Compositions provide stably dispersed waterborne superhydrophobic compositions comprising colloidal silica or hydrophobically-modified fumed silicon dioxide (i.e., silica) and one or more additional agents and/or compounds applied to semi-porous target filter materials and surfaces. More particularly, the present compositions and methods are optimized to provide one or more superhydrophobic surfaces in layered filtration systems provided to users as personal protection equipment (“PPE”). Compositions of the present invention can be applied (e.g., via spray deposition, immersion, liquid application, and the like) to one or more surfaces and allowed to air dry or cured with heat treatment(s).

### FIELD OF THE INVENTION

The present invention relates generally to methods of using stable aqueously dispersed superhydrophobic compositions to provide superhydrophobic treatments on a range of porous and semi-porous target materials and surfaces to enhance the filtration properties of the materials and surfaces. Compositions provide stably dispersed waterborne superhydrophobic compositions comprising colloidal silica or hydrophobically-modified fumed silicon dioxide (i.e., silica) and one or more additional agents and/or compounds applied to semi-porous target filter materials and surfaces. More particularly, the present compositions and methods are optimized to provide one or more superhydrophobic surfaces in layered filtration systems provided to users as personal protective equipment (“PPE”). Compositions of the present invention can be applied (e.g., via spray deposition, immersion, liquid application, and the like) to one or more surfaces and allowed to air dry or cured with heat treatment(s).

### BACKGROUND OF THE INVENTION

### Hazardous Airborne Pathogens and Contaminants

The size of the contaminant is often critically important when it comes to the harmful effects of airborne insults on the human respiratory system. In general, smaller particles are more likely to become airborne and more dangerous. Particles larger than 10 nm usually get collected in upper part of the respiratory system. Therefore, most of particles near 10 nm fail to infiltrate deep into the lungs. However, particles smaller than 10 nm are generally “respirable,” meaning they are capable of infiltrating into deep lung tissues. Respirable agents and particles include, but are not limited to, bacteria, viruses, clays, silts, and some particulates such as tobacco smoke.

Respirable airborne contaminants and infectious agents are present in nearly every environment. Healthcare facilities, communal living accommodations, schools, and crowded workplaces, are all known to posse significant risks for horizontal transmission of airborne respiratory diseases amongst staff, patients, students, and coworkers via respirable pathogens and contaminants. While most respiratory transmissible infections do not result in life threatening diseases for those that are sickened, there are numerous infectious respiratory agents among bacteria, viruses, fungi and molds that are adept at causing dangerous and potentially life threatening diseases in at-risk individuals and even those who are generally healthy. Airborne respiratory secretions from infected individuals, at least in some instances, provide a transmission route for the spread of several important human pathogens including, but not limited to, Measles morbillivirus (Measles disease), Human alphaherpesvirus 3 (“HHV-3”) (e.g., varicella-zoster (“VZV”) the virus that causes Chickenpox virus), Mycobacterium tuberculosis (Tuberculosis disease), Orthomyxoviridae viruses (e.g., Alpha-, Beta-, Delta-, Gamma-influenza viruses), enterovirus (e.g., rhinoviruses, polioviruses, Coxsackie NB, and echoviruses), adenovirus, coronavirus (e.g., Severe Acute Respiratory Syndrome coronavirus (“SARS”), Severe Acute Respiratory Syndrome coronavirus 2 (“SARS-CoV-2”) the virus that causes (“COVID-19”), and, potentially, Human orthopneumovirus (e.g., Human Respiratory Syncytial Virus “RSV”). In healthcare facilities including hospitals and communal residential facilities that have a high number of the elderly and/or immune compromised individuals the risks associated with the airborne transmission of respiratory pathogens is particularly problematic and is a known cause of significant morbidity and mortality in at risk populations.

In industrial workplaces in addition to the dangers posed by airborne respiratory pathogens, additional health risks are associated with inhalation and absorption of airborne toxics, contaminants, and particulates into the respiratory system that can cause life threatening diseases and acute and chronic respiratory conditions.

Additionally, exposure to airborne allergens and particulates in the home can be a source of significant respiratory insult and contribute to acute and chronic respiratory illness particularly in persons already living with respiratory diseases and conditions such as asthma, Chronic Obstructive Pulmonary Disease (“COPD”) and bronchitis.

Protection against Airborne Contaminants Using Personal Protective

The hazard of airborne pathogens and contaminants can be mitigated through the application of basic controls like increasing or providing: adequate ventilation, positive/negative air pressure systems, local air filtration and purification systems (e.g., High-Efficiency Particulate Air “HEPA” filtration), and sanitizing ultraviolet light, and providing individuals with suitable Personal Protective Equipment (“PPE”) such as protective face masks and respirators. Among the many options for increases respiratory health and sanitization articles of PPE such as respirators, face masks, face shields, gloves, booties, gowns and overcoats are typically the most readily available, easily deployable, transportable, and cost effective means of protection.

Protective surgical face masks have been widely used by personnel in hospitals, laboratories, schools and the general public in highly polluted areas, during flu season, and during the recent COVID-19 disease pandemic. Protective surgical face masks are typically composed of one or more filtering layers and/or barriers membranes the efficacy of which determines the level of protection provided by the mask.

Surgical and medical masks and N95 respirators are two of the most popular types of PPE masks on the market. These types of PPE masks have remained virtually unchanged for the last several decades. Studies of surgical masks and N95 respirators in terms of their levels of protection and general comfort have been reported. (See, Atrie, D. and A. Worster, Surgical mask versus N95 respirator for preventing influenza among health care workers: A randomized trial. Canadian Journal of Emergency Medicine, 14(1): pp. 50-52 (2012); and Baig, A. S., et al., Amer. Journal of Infection Control, 38(1) pp. 18-25 (2010)).

Whether the goal is to prevent the outward escape of wearer-generated contaminants or the inward transport of hazardous aerosols, there are two critical requirements to justify the protection level of a mask. First, the filter of the mask must be able to prevent penetration of hazardous particles within a wide range of sizes (from a few nanometers to a few hundred micrometers) over a range of airflow (approximately 10 to 100 L/min). Second, leakage must be avoided at the boundary of the mask and the face. Generally, both requirements (i.e. well-functioning filter and good face seal performance) must be met to claim a mask as being highly protective.

### Surgical Masks

More particularly, a product intended for use as a surgical or medical mask must pass a series of tests according to the standard such as ASTM F2100 or EN14683 to substantiate useful filtration efficiency. For ASTM F2100, the performance of a surgical mask is based on testing for: 1) bacterial filtration efficiency (“BFE”); 2) differential pressure; 3) sub-micron particulate filtration efficiency (“PFE”); 4) resistance to penetration tested by synthetic blood; and 5) resistance to flammability. For typical surgical masks, and in referencing to the BFE test and the sub-micron PFE test, the filtration efficiency percentage must not be lower than 95%. The average size of the aerosol particles in the BFE test is around 3 μm while the average size of the aerosol particles in the sub-micron PFE test is around 0.1 μm.

Aerosolized particles are thought to be trapped by protective masks comprising nonwoven meshes of fibers by a combination of mechanisms including inertial impaction capture, interception capture, and Brownian diffusion capture. Inertial impaction/interception predominates in the BFE test because of the relatively large particle size while Brownian diffusion predominates in the sub-micron PFE test because of the relatively small particle size. The most penetrating particle size (“MPPS”) is 0.3 μm. As both diffusion and impaction/interception are inefficient for particles near the MPPS, passing the aforementioned tests (i.e., BFE test and sub-micron PFE test) does not necessarily equate to a high level of protection.

Surgical and medical masks are designed and constructed to offer superior wearability while at least temporarily blocking large particles, liquid droplets, splashes, sprays, and splatters from reaching the wearer's nose and mouth. Surgical masks are not well designed or constructed to block aerosolized pathogens because they do not seal against the wearer's face. Without an adequate seal to the face, the wearer's inhalations are completely forced through the filter layers and instead can at least partially flow through the gaps in the seal with the wearer's face thus decreasing the level of respiratory protection afforded by because of the possibility of contaminants and pathogens to enter the wearer's nose and mouth. In contrast to surgical mask, respirators are designed and constructed to more tightly seal around the wearer's mouth and nose to provide better when caring for patients with known infectious diseases transmissible via aerosolized pathogens. Thus, respirators (e.g., N95 respirators) provide enhanced protection from exposure to airborne particles and pathogens typically at the expense of user comfort.

### N95 Respirators

Respirators are usually used instead of a surgical mask when a high level of respiratory protection is required because the protective power of surgical mask is generally lower than that of an N95 respirator. There are two main reasons influence the selection, first, the filtration tests for surgical masks do not involve the use of particles at MPPS as the challenge, and second, contaminants can bypass the filtering material of a surgical mask because of infiltration around the looser-fitting surgical mask on the wearer's face. Indeed, case controlled studies during the 2003 SARS crisis demonstrated that N95 respirators were more protective than surgical masks against the SAR coronavirus (Lau, J. T. F., et al., Emerging Infectious Diseases, 10(2): pp. 280-286 (2004); Lu, Y T., et al., Journal of Emergency Medicine, 30(1): pp. 7-15 (2006); Nishiyama, A., et al., Japanese Journal of Infectious Diseases, 61(5): pp. 388-390 (2008); and Yen, M. Y., et al., Journal of Hospital Infection, 62(2): pp. 195-199 (2006)).

N95 designated respirators are the most popular type of PPE respirators used in hospitals and healthcare facilities. For a respiratory product to be designated as being “N95” in the US it must pass the National Institute for Occupational Safety and Health (NIOSH) test which is more stringent than the tests used for surgical masks in terms of protection.

According to NIOSH test neutralized sodium chloride aerosols comprising particles at MPPS are used as the challenge. Neutralized aerosols are used to prevent attraction of particles to the sample by electrostatic force. The flow rate of the sodium chloride aerosols are at 85 L/min. which is higher than the flow rate employed in the BFE test (i.e. 28.3 L/min.). Such flow rates are also higher than the air requirements for a human under most circumstances such as sitting, walking, and even jogging. The filtration efficiency must not be lower than 95% to obtain/maintain an N95 rating. Therefore, N95 respirators are superior to the surgical masks in terms of filtration and protective power.

More particularly, the filter materials used in PPE respirators, such as N95 respirators, are subject to extensive performance selection criteria including, but not limited to, bacterial filtration efficiency, particle filtration efficiency, fluid flow resistance, air flow resistance, flammability and flame propagation, and skin reactivity. (See, National Institute for Occupational Safety and Health (“NIOSH”) guidelines/ https://www.cdc.gov/niosh/npptl/stps/respirator_testing.html/; and 42 Code Federal Regulation Part 84/https://www.cdc.gov/niosh/npptl/topics/respirators/pt84abs2.html). The ability of a filter material, or a multilayer filter system, to prevent a high percentage of aerosolized aqueous associated nanoparticles from passing through its layers determines the respirator's designated filtration level. ASTM F2100-19E1 specifies assessing filtration using 100-nm-sized particles of salt aerosol. ASTM F2101 mandates bacterial filtration efficiency standards. Respirator filters that capture at least 95% of the total particles in a challenge salt aerosol (average particle size of 300 nm under standard conditions) are given a 95 rating. Similarly, materials that trap at least 99% of the total particles in a challenge salt aerosol receive a 99 rating. And those that collect at least 99.97% of the total particles receive a 100 rating. Respirators designations as “N” are not resistant to oil, those designated “R” are somewhat resistant to oil, and, finally, those designated “P” are strongly resistant to oil. Certain industrial oils can remove electrostatic charges from a filter layer/media thus reducing filtration efficiency.

On the one hand, respirators (e.g., N95 respirators) offer a higher degree of protection from airborne pathogens because their snug fitting design and the filtration layers and materials meeting more stringent MPPS challenge during filtration tests. However, the breathability of N95 respirators tends to be lower than surgical mask thus leading to lower user compliance. For example, in a study Moore et al. it was found that despite the high level of protection provided by N95 respirators, many studies of N95 respirators in the US marketplace have shown them to be associated with overall wearer discomfort, diminished visual, vocal, and auditory acuity, excessive humidity and heat, headaches, facial pressure, skin irritation and itchiness, excessive fatigue and exertion, melodiousness, anxiety or claustrophobia, and other interferences with occupational duties. (See, Eck, E. K. and A. Vannier, Infection Control and Hospital Epidemiology, 18(2): pp. 122-127 (1997); Moore, D. M., et al., Journal of the American Association of Occupational Health Nurses, 53(6): pp. 257-266 (2005); and Radonovich Jr, L. J., et al., JAMA, 301(1): pp. 36-38 (2009)).

Thus, even in times of sufficient supply, N95s respirators are not without some deficiencies during extend use. Healthcare workers and patients thus face a dilemma of choosing between a comfortable but less protective mask (i.e., surgical mask), or choosing a highly protective but less comfortable mask (i.e., N95 respirator). It is thus desirable to manufacture protective masks that combine the advantage of surgical masks (i.e., low air resistance) with the filtration advantages of N95 respirators (i.e., high protective power).

The 2020 global healthcare crises related to the pandemic spread of the SARS-CoV-2 virus and the many cases of associated COVID-19 disease related morbidity and mortality underscore the fragility of the global supply chain for PPE articles, and more particularly, the breakdown in supply chain of surgical grade masks and N95 respirators. In times of endemic and even pandemic health crises, the timely manufacture and distribution of respirators, masks, and other pieces of PPE cannot be overstated. The need for highly scalable and rapidly adaptable manufacturing and distribution of protective face masks and PPE respirators to prevent airborne transmission of respiratory pathogens is a matter of critical global health concern.

What is needed are highly effective one, two, three, or more, layered PPE face mask systems comprising one, two, three, or more, layers of filtration materials (e.g., woven fabric(s)) having at least one superhydrophobically treated layer therein to provide levels of filtration of aqueous aerosolized particulates at or near the filtration level of N95 respirators that can be easily manufactured using inexpensive and readily available materials.

### BRIEF DESCRIPTION OF THE DRAWINGS

In the drawings, some embodiments are illustrated by way of example, and not limitation, in the figures of the accompanying drawings in which:

FIGS. 1A-1C illustrate the concept of contact angles on hydrophilic, hydrophobic, and superhydrophobic surfaces.

FIG. 2 shows the fractional transmission rate performance of 2-layer test articles (mask systems) made of Kona cotton. Treatment with DP-AD and DP-HC resulted in significantly decreased fractional transmission rates compared to an untreated 2-layer sample.

FIG. 3 shows the performance of 3-layer test articles (mask systems) wherein the middle layer is treated with a superhydrophobic composition. Untreated samples using heavy cotton t-shirt material performed favorably in comparison to untreated 3-layer Kona cotton. Improvement with addition of both treatments was statistically significant and resulted in fractional transmission rates equivalent to N95 respirators (shown in black line).

FIG. 4 provides a comparison of treated samples having different layer constructions. Tests using a heavy cotton t-shirt/treated Kona cotton/heavy cotton t-shirt construction had no statistically significant difference resulting from the order of layers. While the present invention is not limited to any particular mechanism, it is contemplated that the difference increased transmission of 3B vs 2B and 3D vs 2D can be attributed to an artifact of the test methodology.

FIG. 5 shows the performance of DP-AD treated test articles in comparison to other test face mask articles.

Panels A and B of FIG. 6 show representative fluorescent micrographs of virus-like fluorescent nanoparticles on treated DP-AD Kona cotton after aerosolized water droplet transmission tests. Panel C of FIG. 6 shows a representative fluorescent micrograph for DP-HC Kona cotton sample after testing. More particularly, proceeding according to the fluorescent microscopy methods described in Lustig et al., the virus-like fluorescent nanoparticle trapping behavior of the superhydrophobically treated Multilayered face mask test articles was evaluated. (See, Lustig S. R., et al., “Effectiveness of Common Fabrics to Block Aqueous Aerosols of Virus-like Nanoparticles,” Amer. Chem Soc. Nano, vol. 14, pp. 7651-7658 (2020)). Fluorescent micrographs were generated for DP-AD and DP-HC treated test articles after contact with fluorescent virus-like nanoparticles according to methodologies in Lustig., et al. Bright spots in the images show accumulation of virus like nanoparticles on the fibers. The images are contemplated to provide a qualitative view of the decreased fractional transmission rates provided in treated test articles.

### SUMMARY OF THE INVENTION

The present invention relates generally to methods of using stable aqueously dispersed superhydrophobic compositions to provide superhydrophobic treatments on a range of porous and semi-porous target materials and surfaces to enhance the filtration properties of the materials and surfaces. Compositions provide stably dispersed waterborne superhydrophobic compositions comprising colloidal silica or hydrophobically-modified fumed silicon dioxide (i.e., silica) and one or more additional agents and/or compounds applied to semi-porous target filter materials and surfaces. More particularly, the present compositions and methods are optimized to provide one or more superhydrophobic surfaces in layered filtration systems. Compositions of the present invention can be applied using spray deposition, immersion, liquid application, and similar standard techniques to one or more filtration layers, in single, double, triple, or more, layered systems.

In preferred embodiments, various compositions and methods of the present invention are optimized to functionalize one or more layers of fabric with superhydrophobic properties and/or to enhance the existing hydrophobic properties of the fabric layers. Suitable treatable fabrics include single cotton fabrics and cloths. More generally still, suitable treatable fabrics further comprise woven natural, synthetic, and semisynthetic materials as well as nonwoven natural, synthetic, and semisynthetic materials. Nonwoven layers can comprise, but are not limited to, polypropylene, polyester, polyaramid, and the like. Woven natural layers can comprise, but are not limited to, terry cloth towel, cotton, quilting cotton, flannel, heavy cotton T-shirt material, Kona cotton, denim, and the like.

It is contemplated that three main parameters can be used to select fabrics for manufacturing multilayered fabric PPE articles such as face masks: 1) the degree of efficacy of superhydrophobic composition treatments optimized for air drying and/or optimized for heat curing on the fabric substrate; 2) the availability of the fabric substrate and the similarity of the fabric substrate to those already widely used by the public to make face masks; and 3) the aerosolized droplet filtration efficacy of the fabric substrate as measured using the testing methodology described in S. R. Lustig et al. (Lustig S. R., et al., “Effectiveness of Common Fabrics to Block Aqueous Aerosols of Virus-like Nanoparticles,” Amer. Chem Soc. Nano, vol. 14, pp. 7651-7658 (2020)).

In particularly preferred embodiments, the present invention relates to methods of increasing the filtration and adsorption capabilities of protective fabric face masks (e.g., multilayered woven fabric) by providing methods of treating one or more fabric layers comprising the face mask with a superhydrophobic coating. In this regard, the present invention relates to protective face masks comprising a single layer of fabric, wherein at least one surface of the fabric layer is treated with a superhydrophobic composition. Further embodiments provide protective face masks comprising two layers of fabric, wherein at least one surface of one fabric layer is treated with a superhydrophobic composition. Additional embodiments provide protective face masks comprising three layers of fabric, wherein at least one surface of one fabric layer is treated with a superhydrophobic composition. Further additional embodiments provide protective face masks comprising four layers of fabric, wherein at least one surface of one fabric layer is treated with a superhydrophobic composition. Further additional embodiments provide protective face masks comprising five layers of fabric, wherein at least one surface of one fabric layer is treated with a superhydrophobic composition. The present invention is not intended to be limited to any number or orientation of fabric layers that comprise the face mask, indeed, so long as the mask retains desired filtration, entrapment, and wear characteristics other constructions are within the disclosure of the present invention. The present invention is also not intended to be limited to applications solely comprising one type of fabric layer, for example, fabric and layers made from one or more of abaca, bamboo, cotton, including, but not limited to, heavy cotton T-shirt materials and Kona cotton, coir, hemp, jute, kapok, linen, ramie, ramina, sisal, alpaca, angora, cashmere and mohair, wool, silk, and the like, when otherwise suitable for the application are contemplated. Blends of natural, semi-synthetic, and synthetic fibers/fabrics both woven and nonwoven are further contemplated in additional applications and embodiments of face masks and other types of super-hydrophobically treated PPE articles and garments.

The protective mask can be butterfly-shaped, cup-shaped, duckbill-shaped, or otherwise configured to conform the contours of the wearer's face. Face masks are contemplated to be secured using one or more elastic straps/bands, hook-n-loop fasteners, laces/ties, and the like. Elastic straps can be attached to the left hand side of the main body and the right hand side of the main body of the face mask, respectively, such that the protective mask can be removably fixed onto the wearer's face with the support from the wearer's ears. The elastic straps can also be attached to the upper side of the main body and the lower side of the main body respectively such that the protective mask can be fixed onto the face with the support from the wearer's head. The protective mask of the present invention can be foldable or non-foldable.

In a preferred embodiment, the protective masks of the present invention include a main body comprising at least one layer of woven fabric, two elastic straps, and preferably a semi-rigid but malleable strip (e.g., a metallic or suitable plastic strip) attached to the inner part of the main body to support and to conform the mask to covering the wearer's nose and facial contours.

The main body of the face mask may optionally comprise from two, three, four, or more, woven or nonwoven layers of fabric, that are attached to each other by ultrasonic welding, stitching, adhesives, or other means employed in the fabric and clothing industries. One or more of the fabric layers of the face mask (or other wearable garment, such as, but not limited to, protective garments worn by clinicians during administration of medical procedures including “scrubs”) are coated with a superhydrophobic composition of the present invention on one or both faces of the fabric layer. In some of these embodiments, a superhydrophobic composition is applied to one side of any of the layers such that the coating is not exposed to the environment outside the protective mask; in other embodiments, a superhydrophobic composition is applied to one side of any of the layers such that the coating is exposed to the environment outside the protective mask.

In another embodiment, a first layer of the layered system distal to the face of the wearer and a second layer proximal to the face of the wearer comprise a nonwoven layer such as, but not limited to, spunbond polypropylene microfibers, polyester(s), and polyaramid(s) and the like. One or more of the layers of the face mask (or other type of garment) in these embodiments are preferably coated with a superhydrophobic coating of the present invention on one or both faces of the layer. In some of these embodiments, a superhydrophobic composition is applied to one side of any of the layers such that the coating is not exposed to the environment outside the protective mask; in other embodiments, a superhydrophobic composition is applied to one side of any of the layers such that the coating is exposed to the environment outside the protective mask.

In particularly preferred embodiments, between the inner most fabric layer positioned against the wearer's face, and the outermost fabric layer facing the wearer's environment, there are optionally provided one or more interior fabric layers. In some of these embodiments, when one or more interior layers are present additional superhydrophobic compositions (e.g., coatings) can be applied to the layer(s).

The face masks and other wearable garments of the present invention preferably include at least one fabric layer therein that has been contacted (e.g., coated) with a superhydrophobic composition of the present invention. In this regard the fabric can be said to have been treated with a superhydrophobic composition. In some of these embodiments, the end user of the face mask or other wearable garment directly applies (e.g., spray application and/or immersion) a superhydrophobic composition onto the wearable prior to use or distribution. The end user performs one or more applications of a superhydrophobic composition to a surface of at least one fabric layer of the wearable. Alternatively, the manufacturer of the wearable, which may or may not also be the end user of the wearable, performs one or more applications of a superhydrophobic composition to a surface of at least one layer the wearable. The method used for applying a superhydrophobic composition to a surface of the wearable may comprise, but is not restricted to, immersing the intended fabric layer(s) of the wearable in a bath of superhydrophobic composition of the present invention. In other embodiments, the method used for applying a superhydrophobic composition to a surface of the wearable may comprise, but is not restricted to, spraying (e.g., atomizing) a quantity of a superhydrophobic composition of the present invention onto one or more surfaces of at least one fabric layer of the wearable.

In preferred embodiments, wearable personal protective equipment (e.g., multilayer face mask systems, such as, but not limited to surgical masks; medical gowns (“scrubs”); and other protective garments, such as, but not limited to, foot coverings (“booties”), gloves, jackets, coats, coveralls, and the like) and woven fabrics, more generally, that are treated with a superhydrophobic composition of the present invention filter a higher percentage of aerosolized nanoparticles, such as aerosolized pathogens, than similarly constructed wearables that have not been treated with the compositions described herein.

Thus, particularly preferred embodiments of the present invention provide methods and compositions for increasing the filtering capability of PPE articles (e.g., face masks) to filter, entrap, adsorb, and/or absorb aerosolized nanoparticles (e.g., aerosolized pathogens carried in aqueous droplets) and thus increase the safety associated with use of surgical and non-surgical face masks. The present invention is not intended to be limited to any particular mechanism of to explain the potential mechanical, chemical, or physiochemical bases of the decreased fractional transmission rates achieved when multilayered fabric face mask systems are treated with superhydrophobic compositions of the present invention.

Multilayered fabric face masks comprising two or more layers of woven fabric (e.g., heavy cotton T-shirt material, Kona cotton) when suitably treated with a superhydrophobic composition(s) described herein provide filtration versus aerosolized pathogens that is equal to or nearly equal to (i.e., from about 97.999% to 99.999% N95 normalized permeability index measurement) the filtration obtained from N95 designated respirators under identical use scenarios. The methods of the present invention provide a means for manufacturers and users of multilayered fabric PPE articles, such as face masks, to increase the filtration performance of these articles to statistically equivalent performance levels as those provided by N95 designated articles.

The ability of the wearables described herein when treated with the compositions and methods of the present invention to provide the same, or very nearly the same, level of filtration as N95 designated respirators is surprising given the research of Lustig et al. that showed similar multilayered fabric face masks when treated with a standard perfluoroalkyl super-/hydrophobic coating failed to achieve the filtration provided by N95 designated respirators. (Lustig, S. R., “Effectiveness of Common Fabrics to Block Aqueous Aerosols of Virus-like Nanoparticles,” Amer. Chem Soc. Nano, vol. 14, pp. 7651-7658 (2020)).

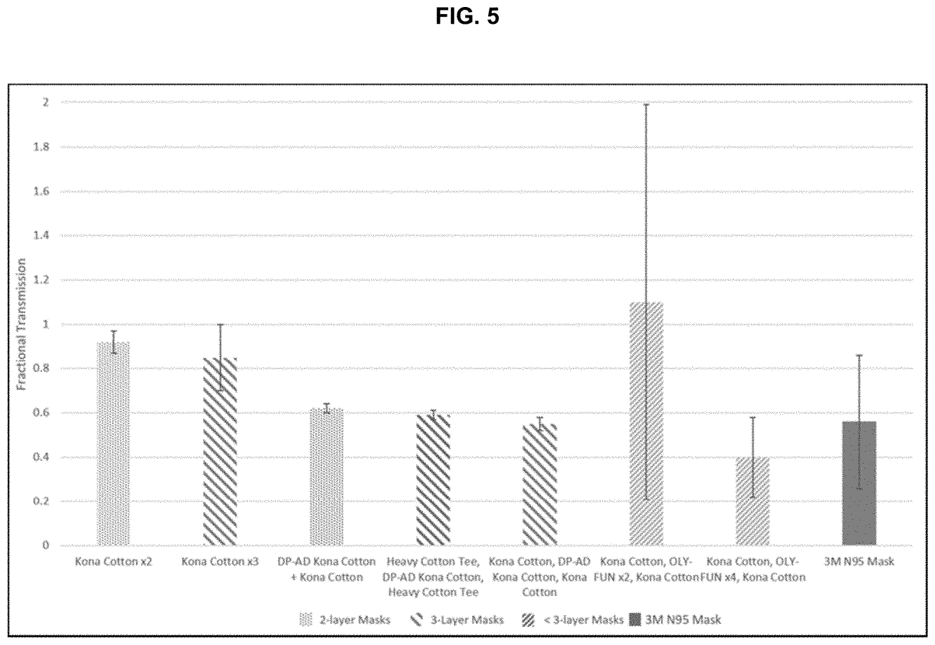

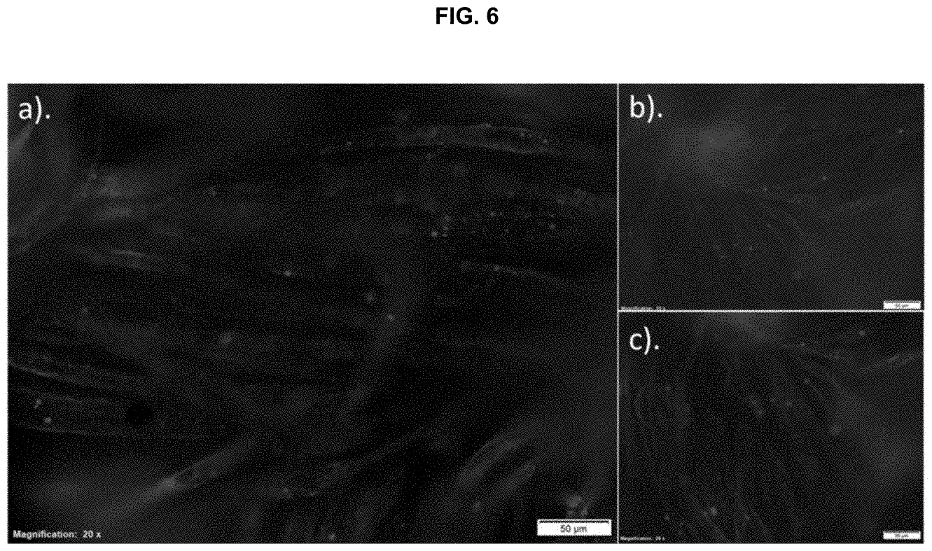

In preferred embodiments, articles treated with a superhydrophobic compositions of the present invention achieved at least a 15.71% reduction in fractional transmission rate for an average of a 27.42% fractional transmission rate decrease across all tests. For example, FIG. 5 shows a comparison between 2 and 3-layer masks treated with superhydrophobic compositions and selected results from the Lustig et al. publication. (See, Lustig S. R., et al., “Effectiveness of Common Fabrics to Block Aqueous Aerosols of Virus-like Nanoparticles,” Amer. Chem Soc. Nano, vol. 14, pp. 7651-7658 (2020)). Treatment of Kona cotton with a superhydrophobic composition decreased the transmission rate of the mask to an N95 equivalent and resulted in a 2-layer treated fabric mask systems outperforming fabric mask systems consisting of three untreated Kona cotton layers.

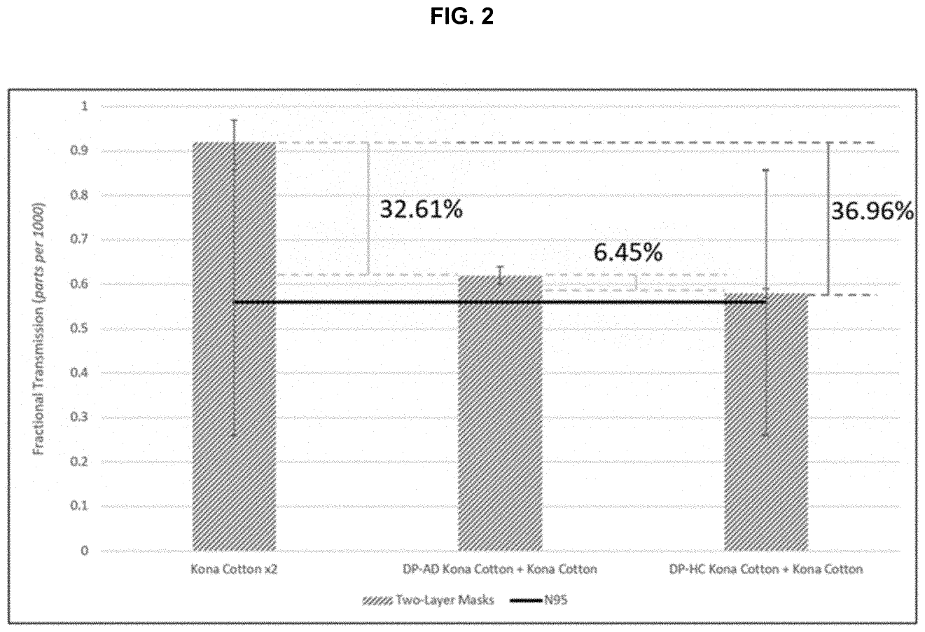

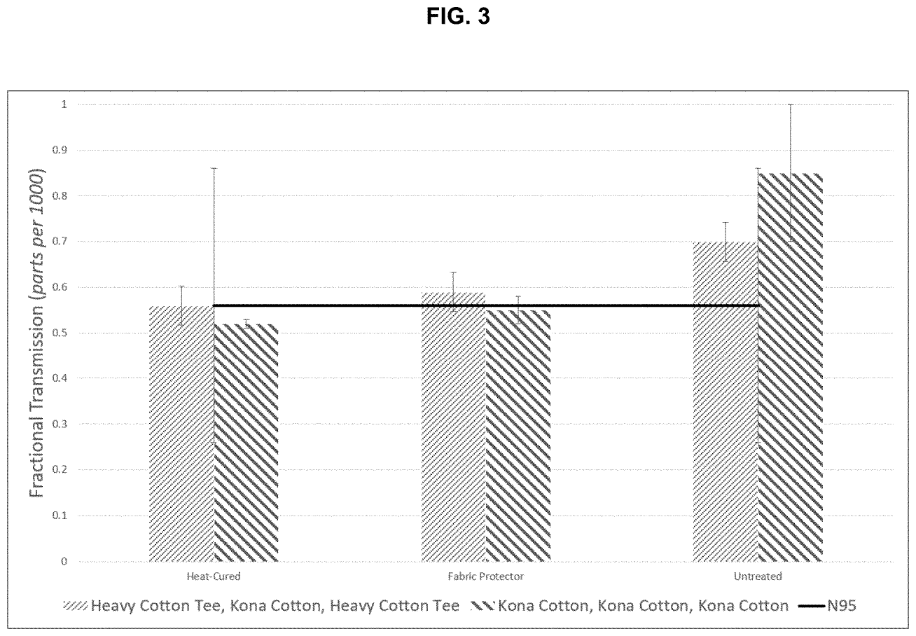

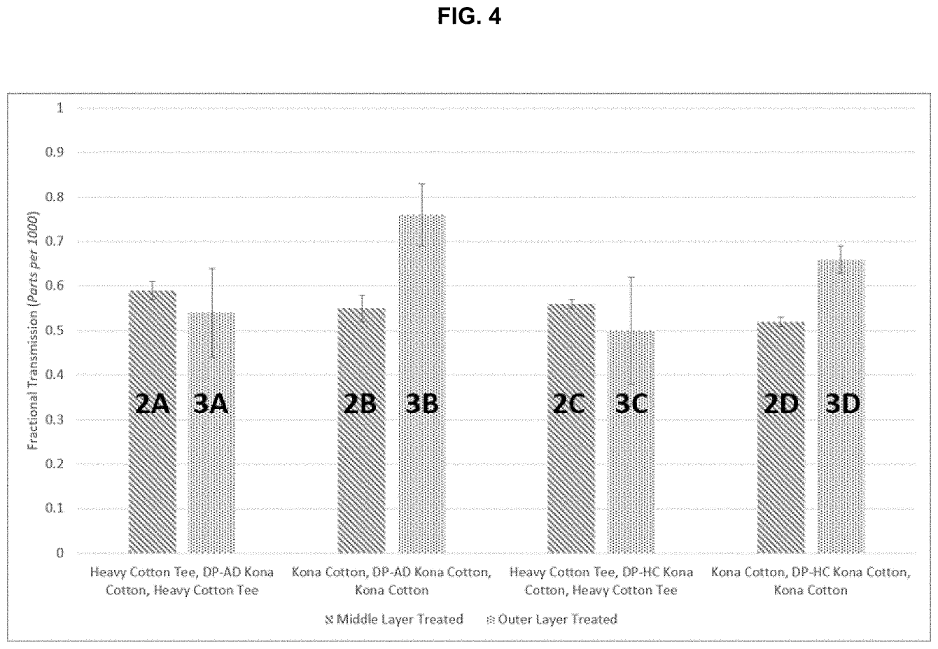

In especially preferred embodiments, superhydrophobic compositions formulated for heat curing onto articles provided statistically significant reductions in the fractional transmission values as compared to air dried formulations. Thus, the present invention contemplates that the selection of the methods and compositions can be tailored to the circumstances and requirements of the use and/or manufacturing cases associated with the multilayered PPE articles (e.g., face masks, surgical masks, medical gowns (“scrubs”), and other protective garments, such as, but not limited to, foot coverings (“booties”), gloves, jackets, coats, coveralls, and the like) and woven fabrics, more generally) while still achieving marked fractional transmission reductions compared to untreated articles. (See e.g., FIG. 2 and FIG. 3).

In still other embodiments, even single layer fabric face masks (e.g., comprising Kona cotton) when treated a superhydrophobic composition of the present invention performed better than two layers of untreated nonwoven polypropylene fabric (i.e., made from OLY-FUN® fabric, JO-ANN Stores, Inc., Hudson, Ohio). (See, FIG. 5).

Various compositions, product formulations, Final Products, and the like, described herein form stable aqueous solutions, suspension, emulsions and the like that are useful in methods of increasing the capability of multilayered fabric PPE wearables (e.g., face mask) to filter aqueous aerosols of virus-like nanoparticles at levels at or very nearly at those of N95 designated respirators.

In preferred embodiments, the compositions are optimized for treating a range of fabric and/or textile based products used in a range of settings and applications, such as, PPE items, building materials and industrial products (e.g., sun screens, awnings, coverings, tarps, etc.), uniforms (e.g., service industries, military, law enforcement, first responders, etc.), consumer products (e.g., clothes, blankets, tents, tarps, bulk fabrics and textiles, etc.) and shoes and articles of clothing, among other items and products. In some embodiments, suitable textiles and fabrics for treatment with the compositions are preferably manufactured or processed using techniques known in the art including, but not limited to, knitting, knotting, crocheting, pressing, weaving, and the like. Suitable textiles and fabrics may further comprise one or more types of fibers or constituents comprising natural materials (e.g., cotton, flax, hemp, silk, wool, and the like), manmade materials (e.g., Acetate, Acrylic/Polyacrylic, Cupro, Elastane, Lyocell/Tencel, Modal, organza, Polyamide/Nylon, Polyester, Rayon, Spandex, Viscose, and the like), and combinations and blends thereof (e.g., Chiffon).

Preferred embodiments of the present invention provide compositions useful for producing a superomniphobic (e.g., one or more characteristics of hydrophobicity, superhydrophobicity, oleophobicity, resisting soiling, resisting fouling, resisting staining, and/or resisting fogging) and like characteristics surface. Various compositions of the present invention are optimized for treating or contacting textile and/or fabric substrates used in articles of clothing, PPE, and other consumer type products designed to be worn or come into contact with a user's skin, preferably, in these embodiments the composition do not substantially alter the softness, color, durability, or breathability, and the like, of the textile or fabric substrate. It is further intended that articles of PPE (e.g., surgical and non-surgical face masks) and clothing treated with the compositions described herein will be at least as easy to clean and care for as the same, or similar, articles that have not been treated with the compositions.

Additional preferred embodiments of the instant compositions and methods provide superhydrophobic compositions that are substantially transparent when applied and that are strongly bonded to the underlying target surface or substrate (e.g., textile and/or fabric). If desired, the substrate may be cleansed or otherwise primed to optimize contact of the liquid solution and adherence of the resulting superhydrophobic coating.

The superhydrophobic compositions described herein are generally non-flammable and non-volatile and environmentally safe. The compositions can also be prepared by simple means and are also highly amenable for deposition by a variety of means (e.g., spraying or dipping) onto any of a variety of substrates to render them superhydrophobic. More particularly, the compositions can be deposited by any of the known deposition techniques, such as, but not limited to, spray-coating, dip-coating, or spin-coating, and the like.

Methods are provided wherein liquid compositions are deposited onto a substrate to form a coated substrate, optionally, followed by subjecting the coated substrate to a drying step to remove the liquid phase of the composition, wherein the composition comprises colloidal silica or hydrophobically-modified fumed silica, an aqueous carrier, and one or more additional modifying agents and/or compounds in contact with one or more layers of multilayered filtration system such as a face mask. In certain of these methods, the aqueous compositions described herein are deposited onto the target surface or intended substrate, followed by exposing the coated substrate to a drying step. In certain embodiments, where a drying step is employed as part of the deposition method, the drying step is practiced by, for example, air drying under ambient conditions, direct heating of the target surface, heating a gas (e.g., air) in contact with the target surface, or more generally, by exposing the target surface to one or more suitable electromagnetic energies. Generally, drying can be enhanced by any method that increases the rate of evaporation of the aqueous component of the composition while maintain the desired superhydrophobic characteristics of the composition following deposition. Where employed, the heating step is generally accomplished at a temperature below the decomposition temperature of the coating solution for sufficient time. For example, in some embodiments, the drying step may employ a temperature of, for example, about 20, 25, 30, 40, 50, 60, 70, 80, 90, 100, 110, 120, 130, 140, 150, 160, 170, 180, 190, 200, 300, 400, 450, 500 ° C., or more, (or within a range bounded by any two of the foregoing values) for a period of time of at least 1, 5, 10, 20, 30, 40, 50, 60, 90, or 120 minutes (or within a range bounded by any two of the foregoing values or within the values).

The superhydrophobic coating of the present invention are contemplated to find use in protecting the underlying substrate (e.g., woven and nonwoven fabrics) from adverse effects caused by contact with any of a variety of liquids, such as aqueous, hydrophilic organic, or hydrophobic organic solvents. More particularly, the substrate may be, for example, a polymer, fabric, or textile. In preferred embodiments, the substrate comprises a fabric or textile. In particularly preferred embodiments, the substrate comprises fabric used in an article of PPE such as face mask.

The resulting coatings are superhydrophobic and preferably strongly adhered to the substrate and optically transparent. The thickness of the superhydrophobic coatings can vary depending on the method of deposition and formulation of the coating. The thickness is typically at least 10 nm (0.01 microns). In different embodiments, the coating may have a thickness of precisely, about, up to, less than, at least, or above, for example, 1 nm, 10 nm, 20 nm, 50 nm, 100 nm, 250 nm, 500 nm, 1000 nm (1 μm), 2 μm, or 5 μm, 10 μm, 50 μm, 100 μm, 150 μm, 200 μm, 250 μm, 300 μm, 350 μm, 400 μm, 500 μm, or 1000 μm (1 mm), 10 nm to 500 nm, or a thickness within a range bounded by any two of these values or within the values.

In some embodiments, the present invention provides compositions and methods for coating a substrate, wherein the method comprises depositing a single layer of the composition on the substrate. In other embodiments, the present invention provides compositions and methods for coating a substrate, wherein the method comprises depositing more than one layer of the composition on a substrate (e.g., a first, and second layer; a first, and second, and third layer, . . . etc.). In embodiments, where more than one layer is deposited, the several coated layers may be the same formulation or one or more different formulations of the present compositions. Where multiple layers of the composition(s) are deposited on a surface, the layers can be of uniform thickness or varying thicknesses and uniform or varying composition. The thickness of the one layer, or various layers, of the inventive coatings can vary according to the demands and needs of a given application.

The compositions are preferably prepared without any fluorine containing components (e.g., perfluoroalkyl substances) in the Final Products. Accordingly, in some preferred embodiments, the compositions comprise stable aqueously dispersed treatments comprising colloidal silica or hydrophobically-modified fumed silica and one or more additional components (agents) with the proviso that said composition comprise substantially no fluorine containing components therein.

In still other embodiments, the compositions comprise stable aqueously dispersed treatments comprising colloidal silica or hydrophobically-modified fumed silica and one or more additional components with the proviso that there are no fluorine containing components therein. While the present invention is not limited to any formulation, favored compositions provide environmentally safe non-fluorine containing hydrophobic and superhydrophobic treatments and methods of using these treatments on PPE items like multilayer face mask systems, such as, but not limited to surgical masks; medical gowns (“scrubs”); and other protective garments, such as, but not limited to, foot coverings (“booties”), gloves, jackets, coats, coveralls, and the like) and woven fabrics, more generally.

### DEFINITIONS

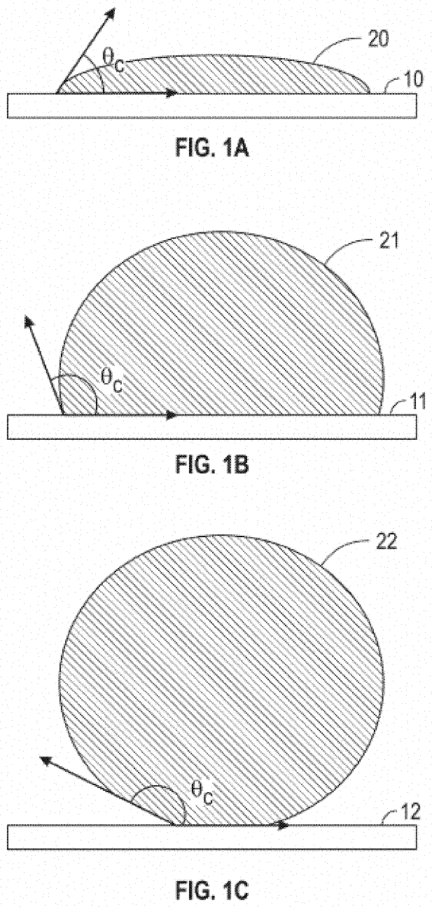

As used herein, the term “hydrophilic surface” is defined as a surface that produces a contact angle of less than 90° with a droplet of water. The term “hydrophobic surface” is defined as a surface that produces a contact angle of at least 90° but no greater than 150° with a droplet of water. And the term “superhydrophobic” is defined as a surface (i.e., coated with the instant superhydrophobic compositions and formulations) that produces a contact angle of more than 150° with a droplet of water. A “contact angle” (θ_{c}) is the angle where a liquid-vapor surface meets a solid surface and it quantifies the wettability of a solid surface by the liquid. FIGS. 1A-1C illustrate the concepts of contact angles on hydrophilic, hydrophobic, and superhydrophobic surfaces. In each of FIGS. 1A-1C, a water droplet rests on a surface and exhibits a different “contact angle.” In FIG. 1A, surface 10 is a hydrophilic surface and produces a contact angle θ_{c} with water droplet 20 that is less than 90°. In FIG. 1B, surface 11 is a hydrophobic surface and produces a contact angle θ_{c} with water droplet 21 that is greater than or equal to 90° but less than or equal to 150°. In FIG. 1C, surface 12 is said to be a superhydrophobic surface (i.e., coated with the instant superhydrophobic compositions and formulations) and thusly produces a contact angle θ_{c} with water droplet 22 that is greater than 150°.

As used herein, the term “nanoparticles” refers to particles having a size of between 1 and 100 nanometers, and more preferably, from between 10 nm to 50 nm.

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a composition, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

Recitation of ranges of values herein are merely intended to serve as a shorthand method of referring individually to each separate value falling within the range, unless otherwise indicated herein, and each separate value within the range is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Unless otherwise defined herein, technical terms used in connection with the present invention shall have the meanings that are commonly understood by those of ordinary skill in the art. The meaning and scope of the terms should be clear, however, in the event of any latent ambiguity, definitions provided herein take precedent over any dictionary or extrinsic definition. In this application, the use of “or” means “and/or” unless stated otherwise.

As used herein, the term “ normalized permeability index” measurement has the meaning and use as provided in Lustig S. R., et al., “Effectiveness of Common Fabrics to Block Aqueous Aerosols of Virus-like Nanoparticles,” Amer. Chem Soc. Nano, vol. 14, pp. 7651-7658 (2020).

The term “fractional transmission” has the meaning and use as provided in Lustig S. R., et al., “Effectiveness of Common Fabrics to Block Aqueous Aerosols of Virus-like Nanoparticles,” Amer. Chem Soc. Nano, vol. 14, pp. 7651-7658 (2020).

As used herein, the term “N95-normalized fractional transmission” has the meaning and use as provided in Lustig S. R., et al., “Effectiveness of Common Fabrics to Block Aqueous Aerosols of Virus-like Nanoparticles,” Amer. Chem Soc. Nano, vol. 14, pp. 7651-7658 (2020).

Where a percentage is provided with respect to an amount of a component, agent, or material in a particular composition or formulation, the percentage should be understood to be a percentage based on weight, unless otherwise stated or understood from the context.

Where a molecular weight is provided and not an absolute value, for example, of a component, agent, or material in a particular composition or formulation, the molecular weight should be understood to be an average molecule weight, unless otherwise stated or understood from the context.

The order of steps or order for performing certain actions is immaterial so long as the present teachings remain operable. Moreover, two or more steps or actions may be conducted simultaneously.

At various places in the present specification, numerical values are disclosed in groups or in ranges. It is specifically intended that the description include each individual sub-combination of the members of such groups and ranges and any combination of the various endpoints of such groups or ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

### DESCRIPTION OF THE INVENTION

The present invention relates generally to methods of using stable aqueously dispersed superhydrophobic compositions to provide superhydrophobic treatments on a range of porous and semi-porous target materials and surfaces to enhance the filtration properties of the materials and surfaces. Compositions provide stably dispersed waterborne superhydrophobic compositions comprising colloidal silica or hydrophobically-modified fumed silicon dioxide (i.e., silica) and one or more additional agents and/or compounds applied to semi-porous target filter materials and surfaces. More particularly, the present compositions and methods are optimized to provide one or more superhydrophobic surfaces in layered filtration systems provided to users as personal protection equipment (“PPE”). Compositions of the present invention can be applied (e.g., via spray deposition, immersion, liquid application, and the like) to one or more surfaces and allowed to air dry or heat-cured with heat treatment(s).

The colloidal silica or fumed silica is dispersed in water such that the hydrophobic qualities of the surface-modified silica are largely maintained. In some preferred embodiments, the hydrophobic qualities of the surface-modified silica are maintained by inclusion of one or more additives that provide or augment the desired chemical, physiochemical, rheological, etc., properties of the formulation. For example, in some embodiments, comprise one or more additives including dispersants, defoamers, rheology-modifying agents (e.g., thickening agents), polymers, ammines (e.g., AMP-95 (Angus Chemic Co., Buffalo Grove, Ill.), and NH₃), surface wetting agents, and/or binding agents, or other suitable additives that provide the desired characteristics in the final formulation. While the present invention is not limited to any particular mechanism of action, it is nevertheless contemplated that the superhydrophobic performance of the dried coatings results from deposition of the colloidal silica or hydrophobically-modified fumed silica in combination with the action of the one or more aforementioned additives.

In general, the preparation of stable aqueous dispersions of the superhydrophobic coatings is accomplished using a three-stage process preferentially encompassing: 1) a pre-gel stage; 2) a grind stage; and 3) a let-down stage. The General Dispersing Process and Examples provided below describe these production processes in greater detail.

### General Dispersing Process

Methods of making superhydrophobic compositions comprising hydrophobically-modified fumed silicon dioxide as a class of compositions are generally known in the art. The present compositions provide the art with stable aqueous dispersions of colloidal silica or hydrophobically-modified fumed silicon dioxide as superhydrophobic coatings. The methods for making the stable aqueous dispersions of the present invention generally follows those methods as known in the art with the addition of certain preferred agents, as described in herein, that enhance the aqueous dispersion, stability, and coating properties of the compounds.

Step one: comprises a pre-gel formation stage wherein preferably a combination of wetting agents, clay rheology modifiers, and defoamers in water, are mixed under low to high shear conditions. Preferred compositions comprise from about 0.100% to about 5%, and more preferably from, 0.25% to 3% solids. The clay additives are dispersed in water, and the thickening effects are activated by complete deagglomeration of clay particles. The pre-gel solution is stable (i.e., 45 days or more without noticing any separation at 25 C, 50% relative humidity) and can be prepared in advance of the remaining steps.

Step two: (let down step) comprises a grinding and milling stage wherein the pre-gel solution is deagglomerated and the colloidal silica or fumed silica particles are dispersed in the aqueous solution. At this stage, additionally, dispersant and co-dispersant additives, rheology modifiers, defoaming agents are added to stabilize and aid the grind. In some cases, depending on the clay thickener(s) used, the grind stage is carried out after addition of pre-gel solution. The grinding process is preferably carried out using a high-shear dispersing blade for a period of from about 20 to 70 minutes. A stable dispersion of colloidal silica or fumed silica is obtained at the completion of the grind stage. The dispersion is stable and can be stored, or further diluted to the desired formulation viscosity to provide a finished composition.

Step three: comprises, in some embodiments, preferably adding one or more defoaming agents, and/or one or more wetting agents, and/or one or more binding agents to the pre gel of to the product of Step 2 or as described in the Examples. A final dilution of the composition with additional water under low shear mixing conditions can optionally be used at this point to provide a finished composition. Since the viscosity is being lowered, this step is preferably carried out under low shear with a propeller mixer or a Cowles blade.

### Exemplary Hydrophobing and Binding Agents

The superhydrophobic coatings of the present invention comprise hydrophobically treated fumed silica particles and alkoxysilane compounds functionalized with alkyl groups. The hydrophobically treated fumed silica particles and functionalized alkoxysilane compounds, as part of the superhydrophobic coating system, are operative components for providing the desired hydrophobicity.

In preferred embodiments, the hydrophobized fumed silica is obtained by treating silica with silane or siloxane compounds post-pyrolysis to producing methyl, dimethyl, or siloxane functionalities. Alternatively, in other embodiments, untreated silica is used as a binding agent, surface roughening agent, or as a binding surface for silane species.

Silane (SiH₄) is a colorless inorganic pyrophoric gas having a strongly malodorous smell. Generally, the term silanes refers to many compounds with four substituents on silicon, including an organosilicon compound, typical examples of silanes include trichlorosilane (SiHCl₃), tetramethylsilane (Si(CH₃)₄), and tetraethoxysilane (Si(OC₂H₅)₄). Binding agents suitable for use in the compositions and formulations of the present invention are generally comprised of: aqueous emulsions of alkylalkoxysilane(s), emulsions of modified polysiloxane resins, methyltrimethoxysilanes, methyltriethoxysilanes, aqueous emulsion of silicone resins, aqueous emulsions of alkylurethanes, aqueous dispersions of polymeric wax, waterborne silicone emulsions, amino-functional siloxane emulsions, and monomeric alkylalkoxysilanes.

In certain embodiments, suitable silane and/or binding agent compounds include, but are not limited to, PROTECTOSIL® BHN PLUS (Evonik Industries, AG, Essen, Germany), DYNASYLAN® SIVO 850 (Evonik Industries) DYNASYLAN® MTES, DYNASYLAN® MTMS, and alkyl-methoxy silanes (Gelest, Inc., Morrisville, Pa.), TEGO® Phobe 1650 (Evonik Industries), KM-9769 (Shin-Etsu Chemical, Co., Ltd., Ōtemachi, Japan), Zelan™ CA-72 (Chemours Inc., Wilmington, Del.), CoatOSil DRI (Momentive Performance Materials Inc., Columbus, Ohio), CoatOSil 2059, and Silquest A-137 (Momentive Performance Materials Inc.)

The compositions and formulations of the present invention generally comprise one or more binding agents from about 0.01 wt % to about 30.0 wt %, and more preferably, from about 0.2 wt % to about 20.00 wt %, and more preferably from 1.0 wt % to about 5.0 wt %.

Additionally, certain compositions further comprise one or more waterborne dispersions and emulsions of hydrocarbon blends such as, but not limited to, LUBA print 280/w and 280/F (Münzing Chemie, Abstatt, Germany), Carnaluba blend like LUBA print 434/F, paraffinic blends such as LUBA print 445/w, polyethylene blends such as Luba print 942, and blends of the above, such as Wükoseal 2800 (Süddeutsche Emulsions-Chemie GmbH, Mannheim, Germany).

Fumed silica, also known as pyrogenic silica because it is produced in a 3000 ° C. electric arc, consists of microscopic droplets of amorphous silica fused into branched, chainlike, three-dimensional secondary particles which then agglomerate into tertiary particles. The resulting powders have an extremely low bulk density and high surface area. The three-dimensional structures of fumed silica increase viscosity and enhance thixotropy of aqueous compositions. Generally, suitable hydrophobic silicas are selected from, but not limited to, fumed silica after-treated with polydimethylsiloxane, fumed silica after-treated with an organosilane, and fumed silica after-treated dimethyldichlorosilane. Examples of hydrophobic fumed silica used in the certain formulations include, but are not limited to, AMSIL™-F H22 (Brenntag, Inc., Toronto, Ontario, Canada), AEROSIL® R 202 (Evonik Industries), AEROSIL® R 202, AEROSIL® R 208, AEROSIL® R 812, and AEROSIL® R 972. The compositions and formulations of the present invention generally comprise one or more one or more hydrophobic silicas from about 0.001 wt % to about 3.0 wt %, and more preferably, about 0.50 wt %.

Generally, fumed silica is available at high purity, typically, about 99% pure and having a primary particle size range from about 5-50 nm. Fumed silica particles are non-porous and have a surface area of 50-600 m²/g.

Suitable hydrophilic silicas are selected from, but not limited to, untreated thermal silica, sodium-stabilized colloidal silica, ammonia-stabilized fumed silica dispersions, and potassium-stabilized fumed silica dispersion. Examples of untreated silica (hydrophilic) include, but are not limited to, LUDOX® TM-50 (WR Grace, Columbia, Md.), Cab-O-Sperse® 1020K Cabot Corp., Billerica, Mass.), Cab-O-Sperse® 1030K, AERODISP W 7520 (Evonik Industries), AEROSIL® 200 (Evonik Industries), AEROSIL® 300, and ACEMATT® TS100 (Evonik Industries). The compositions and formulations of the present invention generally comprise one or more one or more hydrophilic silicas from about 0.001 wt % to about 1.0 wt %, and more preferably, about 0.30 wt %.

### Exemplary Dispersing, Surface Tension Reducing, and Stabilizing Additives

Exemplary rheology-modifying additives comprise, but are not limited to, urethane, phyllosilicate clay, synthetic clay thickeners, and associative thickeners for aqueous systems (e.g., solutions of polyurethane(s) such as pseudoplastic polyurethane associative thickeners; phyllosilicate clays, and/or Newtonian urethane thickeners, and/or, combinations thereof). While the present invention is not limited to any particular mechanism(s) it is contemplated that shear-dependent and thixotropic behaviors in formulations are produced and/or augmented by various singular incorporations, or combinations, of these types of thickening agents to aid in the dispersion process and as anti-settling agents among other stabilizing effects. In certain embodiments, the present formulations (i.e., the present dispersed formulations) are additionally thickened by the addition of one or more acrylic or acrylic urethane emulsions that further prevent the settling of the dispersed formulation elements.

Suitable thickening additives and/or additional aqueous polymers are selected from, but not limited to, synthetic layered silicates, synthetic layered silicates further incorporating inorganic polyphosphate peptiser, activated phyllosilicates, solutions of polyurethanes, non-ionic solutions of polyurethanes, acrylic emulsions, and acrylic urethane emulsions. Suitable exemplary, thickening additives comprise, but are not limited to, OPTIFLO® L1400 (RHEOBYK®-L 1400, RHEOBYK®-H 6500VF) (BYK-Chemie, GmbH, Wesel, Germany), OPTIFLO® H6500VF, OPTIGEL® WX (BYK-Chemie), OPTIGEL® LX, LAPONITE® RDS (BYK-Chemie), LAPONITE® S 482, JONCRYL® 77 (BASF Corp., Florham Park, N.J.), NEOPACK® R9036 (DSM LLC, Wilmington, Mass.), NEOPACK® R9045, TEGO VISCOPLUS® 3010 (Evonik Industries), or TEGO VISCOPLUS® 3030. The compositions and formulations of the present invention generally comprise one or more thickening agents from about 0.001 wt % to about 3.0 wt %, and more preferably, from about 0.05 wt % to about 0.25 wt %.

The various dispersed aqueous compositions and formulations are further stabilized by the addition of one or more polymeric dispersant agents contemplated to provide steric stabilization. Exemplary suitable dispersant agents comprise block copolymer solutions, and acrylate copolymer emulsions, and more particularly, include, but not limited to, one or more high molecular weight block copolymers, emulsions of a structured acrylate copolymers, and solutions of copolymers with pigment-affinic groups, and the like. Exemplary dispersants include, but are not limited to, one or more DISPERBYK®-190 (BYK-Chemie), DISPERBYK®-2010, DISPERBYK®-2080, and DISPERBYK®-2081. The compositions and formulations of the present invention generally comprise one or more dispersants/codispersants from about 0.01 wt % to about 2.0 wt %, and more preferably, from about 0.02 wt % to about 0.05 wt %.

Additionally, defoaming additives are added to retard foam creation caused by additives, silica, or shearing action of the dispersion process. Suitable defoamers generally include both silicone-free and silicone-containing polymer defoamers. Exemplary defoamers include, but are not limited to, BYK-011 (BYK-Chemie) and BYK-022. The compositions and formulations of the present invention generally comprise one or more defoamers from about 0.001 wt % to about 1.0 wt %, preferably, about 0.10 wt %, and more preferably, about .05 wt %.

In some preferred embodiments, surface tension in the aqueous carrier is moderated (e.g., reduced) by the optional addition of one or more wetting agents such as, but not limited to, tetramethyldecynediol gemini surfactants, ethoxylated acetylenic gemini surfactants, polyether siloxane copolymers, polyether-modified siloxane, and polyether-modified polysiloxane surfactants. Exemplary surface tension reducing agents and surfactants suitable for use in certain embodiments include, but are not limited to BYK® 346 (BYK-Chemie), BYK® 347, BYK® 348, SURFYNOL® 104DPM (Evonik Industries), TEGO® Wet 260 (Evonik Industries), DYNOL® 604 (Evonik Industries), and DYNOL® 607. The compositions and formulations of the present invention generally comprise one or more wetting agents from about 0.001 wt % to about 1.0 wt %, and more preferably, from about 0.05 wt % to about 0.15 wt %.

Additionally, in still some other embodiments, one or more cosolvents and/or one or more co-dispersants are added to the compositions and formulations to aide film formation and stability. Suitable cosolvent or co-dispersant species include AMP-95 (Angus Chemical Co.), isopropyl alcohol, ethanol, propylene glycol methyl ether, propylene glycol n-propyl ether, dipropylene glycol n-propyl ether, dipropylene glycol methyl ether, dipropylene glycol n-butyl ether, tripropylene glycol n-butyl ether, propylene glycol n-butyl ether, and 3-methoxy-3-methyl-1-butanol. Cosolvents are typically added to a primary solvent to increase the solubility of poorly soluble compounds and/or to improve film-forming characteristics; similarly, co-dispersants are added to increase the dispersion of the formulation as a whole or of one or more constituents (e.g., elements or chemical compounds) contained therein. The compositions and formulations of the present invention generally comprise one or more cosolvents from about 0.1 wt % to about 15.0 wt %, and more preferably, from about 1.00 wt % to about 10.00 wt %.

In other embodiments, the compositions further comprise one or more fast-evaporating, hydrophobic glycol ethers having high solvency and good to excellent coupling ability such as, but not limited to, PnP glycol ether, PnB glycol ether, DPnB glycol ether and/or ethylene glycol ethers (e.g., EB), and the like. The compositions and formulations of the present invention generally comprise one or more hydrophobic glycol ethers from about 1.0 wt % to about 8.0 wt %, and more preferably, from about 3.00 wt % to about 4.0 wt %.

### Exemplary Aerosol Applicators and Aerosolized Treatments and Coatings

The compositions can be applied to a target substrate using any number of aerosolization technologies and devices comprising a pressurized propellant gas such as volatile organic compounds (VOCs) including, naturally occurring hydrocarbons (e.g., typically propane, n-butane and isobutene, dimethyl ether (DME), or methyl ethyl ether), carbon dioxide, nitrous oxide, or air. Suitable aerosol dispensing systems comprise self-contained air-tight pressurized containers typically cylindrically shaped having an actuator mechanism for triggering delivery of the product through a nozzle system that focuses and concentrating the product.

Preferred embodiments of the present invention employ a compressed air system to avoid the use of VOC, hydrocarbon, and carbon dioxide as propellants. Similarly, the use of hydrofluoroalkane propellants is unnecessary. Suitable piston barrier systems that use compressed air propellant are described in U.S. Pat. No. 9,790,019; U.S. Pat. No. 9,550,621; US20170327301; and EP3250475A1. In preferred embodiments, compressed air delivery devices are obtained from Airopack Technology Group AG (Waalwijk, The Netherlands). Other embodiments of the invention are optimized for delivery using bag-in-can or bag-on-valve aerosolization systems and devices.

### DETAILED DESCRIPTION OF THE INVENTION

The invention is further disclosed and illustrated in the working examples. The working examples are merely illustrative of selected specific embodiments of the invention and are not intended to be construed to limit its scope. Given the disclosure, one of ordinary skill in the art can routinely modify the process as necessary or desired.

### Example 1

This Example provides Dispersion Process Formula 1, as shown in Table 1A, and the process steps incorporating this Formula to produce a dispersed silica solution called Intermediate Product 1. A quantity of Intermediate Product 1 was subsequently processed with additional agents as shown in Table 1B as per the processes described herein to produce a stable aqueously dispersed superhydrophobic composition called Product Formulation 1.

TABLE 1A
Dispersion Process Formula 1

| Component | Mass (g) |
|---|---|
| Dynol 604 | 0.89 |
| BYK-346 | 2.68 |
| BYK-022 | 1.78 |
| Laponite RDS | 4.46 |
| Rheobyk-L 1400 | 0.89 |
| Rheobyk-H 6500VF | 0.89 |
| Disperbyk 2080 | 0.89 |
| Acematt TS100 | 5.35 |
| Joncryl 77 | 2.68 |
| DSM NeoPac R-9045 | 2.68 |
| DSM NeoPac R-9036 | 2.68 |
| DPM Glycol Ether | 0.89 |
| Isopropyl Alcohol | 50.00 |
| Water | 419.14 |

Into a 1-quart steel mixing pot, 136.24 g of water was combined with 0.21 g of BYK-022, 8.92 g of Laponite RDS, and 0.39 g of Dynol 604, the combination was mixed with an IKA RW-20 overhead stirrer affixed with a dispersing blade at a rate of 2500 rpm for 30 minutes. The resultant thickened mixture was then combined with 0.89 g of Disperbyk 2080, 5.35 g of Acematt TS100, 2.68 g of Joncryl 77, 2.68 g of DSM NeoPac R-9045, 2.68 g of DSM NeoPac-9036, 0.89 g of Rheobyk-L 1400, and 0.89 g of Rheobyk-H 6500VF. This mixture was dispersed with the overhead stirrer operated at a rate of 2500 rpm for 30 minutes until a Hegman gauge value of 7 was measured. The dispersed silica formula was let-down with 188.60 g of water while mixing with the overhead stirrer fitted with a propeller blade at 1500 rpm, and 2.68 g of BYK-346, 0.50 g of Dynol 604, 1.57 g of BYK-022, 5.00 g of DPM glycol ether, and 50 g of isopropyl alcohol were added before dilution with an additional 94.30 g of water. Intermediate Product 1 was obtained after stirring for an additional 60 minutes.

TABLE 1B
Product Formulation 1

| Component | Mass (g) |
|---|---|
| Intermediate Product 1 | 28.04 |
| Water | 59.85 |
| DPM Glycol Ether | 0.72 |
| PnB Glycol Ether | 2.00 |
| Ispropyl Alcohol | 2.20 |
| DPnB Glycol Ether | 2.00 |
| Tego Phobe 1650 | 5.00 |
| Dynasylan MTES | 0.20 |

In a 1-quart steel mixing pot stirred at a rate of 1500 rpm with an IKA RW-20 overhead stirrer fitted with a propeller blade, 28.04 g of Intermediate Product 1 comprising a dispersed silica solution was combined with 59.85 g of water, 2.00 g of PnB glycol ether, 0.72 g of DPM glycol ether, 2.20 g of isopropyl alcohol, 2.00 g of DPnB glycol ether, 5.00 g of Tego Phobe 1650, and 0.20 g of Dynasylan MTES. The pot was stirred for 30 minutes to obtain the stable aqueously dispersed superhydrophobic composition called Product Formulation 1.

### Example 2

This Example provides Dispersion Process Formula 2, as shown in Table 2A, and the process steps incorporating this Formula to produce a dispersed silica solution called Intermediate Product 2. A quantity of Intermediate Product 2 was subsequently processed with additional agents as shown in Table 2B as per the processes described herein to produce a stable aqueously dispersed superhydrophobic composition called Product Formulation 2.

TABLE 2A
Dispersion Process Formula 2

| Component | Mass (g) |
|---|---|
| Dynol 604 | 0.89 |
| BYK-346 | 2.68 |
| BYK-011 | 1.78 |
| Optigel WX | 2.68 |
| Rheobyk-L 1400 | 0.89 |
| Rheobyk-H 6500VF | 0.89 |
| Disperbyk 2080 | 0.89 |
| Aerosil R 812 | 5.35 |
| Joncryl 77 | 1.78 |
| DSM NeoPac R-9045 | 1.78 |
| DSM NeoPac R-9036 | 1.78 |
| DPM Glycol Ether | 5.00 |
| Isopropyl Alcohol | 50.00 |
| Water | 423.60 |

In a 1-quart steel mixing pot, 140.70 g of water was combined with 0.21 g of BYK-011, 2.68 g of Optigel WX, and 0.39 g of Dynol 604 and was mixed with an IKA RW-20 overhead stirrer affixed with a dispersing blade at a rate of 2500 rpm for 30 minutes. This thickened mixture was combined with 0.89 g of Disperbyk 2080, 5.35 g of Aerosil R 812, 1.78 g of Joncryl 77, 1.78 g of DSM NeoPac R-9045, 1.78 g DSM NeoPac R-9036, 0.89 g of Rheobyk-L 1400, and 0.89 g of Rheobyk-H 6500VF. This mixture was dispersed with the overhead stirrer operated at a rate of 2500 rpm for 30 minutes until a Hegman gauge value greater than 7 was measured. The dispersed silica formula was let down with 188.60 g of water while mixing with the overhead stirrer fitted with a propeller blade at 1500 rpm, and 2.68 g of BYK-346, 0.50 g of Dynol 604, 1.57 g of BYK-011, 5.00 g of DPM glycol ether, and 50 g of isopropyl alcohol were added before dilution with an additional 94.30 g of water. Intermediate Product 2 was obtained after stirring for an additional 60 minutes.

TABLE 2B
Product Formulation 2

| Component | Mass (g) |
|---|---|
| Intermediate Product 2 | 28.04 |
| Water | 44.05 |
| DPM Glycol Ether | 0.72 |
| Isopropyl Alcohol | 7.20 |
| Shin-Etsu X-51-1302M | 20.00 |

In a 1-quart steel mixing pot stirred at a rate of 1500 rpm with an IKA RW-20 overhead stirrer fitted with a propeller blade, 28.04 g of Intermediate Product 2 was combined with 44.05 g of water, 0.72 g of DPM glycol ether, 7.2 g of isopropyl alcohol, and 20.00 g of Shin-Etsu X-51-1302M. The pot was stirred for 30 minutes to obtain the stable aqueously dispersed hydrophobic composition called Product Formulation 2.

### Example 3

This Example provides Dispersion Process Formula 3, as shown in Table 3A, and the process steps incorporating this Formula to produce a dispersed silica solution called Intermediate Product 3. A quantity of Intermediate Product 3 was subsequently processed with additional agents as shown in Table 3B as per the processes described herein to produce a stable aqueously dispersed superhydrophobic composition called Product Formulation 3.

TABLE 3A
Dispersion Process Formula 3

| Component | Mass (g) |
|---|---|
| Dynol 604 | 0.89 |
| BYK-346 | 2.68 |
| BYK-011 | 1.78 |
| Optigel WX | 2.68 |
| Tego Viscoplus 3010 | 1.78 |
| Tego Viscoplus 3030 | 1.78 |
| Disperbyk 2080 | 0.89 |
| Aerosil R 812 | 5.35 |
| Joncryl 77 | 1.78 |
| DSM NeoPac R-9045 | 1.78 |
| DSM NeoPac R-9036 | 1.78 |
| DPM Glycol Ether | 5.00 |
| Isopropyl Alcohol | 50.00 |
| Water | 423.60 |

In a 1-quart steel mixing pot, 138.92 g of water was combined with 0.21 g of BYK-011, 2.68 g of Optigel WX, and 0.39 g of Dynol 604 and was mixed with an IKA RW-20 overhead stirrer affixed with a dispersing blade at a rate of 2500 rpm for 30 minutes. This thickened mixture was combined with 0.89 g of Disperbyk 2080, 5.35 g of Aerosil R 812, 1.78 g of Joncryl 77, 1.78 g of DSM NeoPac R-9045, 1.78 g of DSM NeoPac R-9036, 1.78 g of Tego Viscoplus 3010, and 1.78 g of Tego Viscoplus 3030. This mixture was dispersed with the overhead stirrer operated at a rate of 2500 rpm for 30 minutes until a Hegman gauge value of 7 was measured. The dispersed silica formula was let down with 188.60 g of water while mixing with the overhead stirrer fitted with a propeller blade at 1500 rpm, and 2.68 g of BYK-346, 0.50 g of Dynol 604, 1.57 g of BYK-011, 5.00 g of DPM glycol ether, and 50 g of isopropyl alcohol were added before dilution with an additional 94.30 g of water. Intermediate Product 3 was obtained after stirring for an additional 60 minutes.

TABLE 3B
Product Formulation 3

| Component | Mass (g) |
|---|---|
| Intermediate Product 3 | 28.04 |
| Water | 44.05 |
| DPM Glycol Ether | 0.72 |
| Isopropyl Alcohol | 7.20 |
| Shin-Etsu X-51-1302M | 20.00 |

In a 1-quart steel mixing pot stirred at a rate of 1500 rpm with an IKA RW-20 overhead stirrer fitted with a propeller blade, 28.04 g of Intermediate Product 3 was combined with 44.05 g of water, 0.72 g of DPM glycol ether, 7.2 g of isopropyl alcohol, and 20.00 g of Shin-Etsu X-51-1302M. The pot was stirred for 30 minutes to obtain the stable aqueously dispersed superhydrophobic composition called Product Formulation 3.

### Example 4

This Example provides Dispersion Process Formula 4, as shown in Table 4A, and the process steps incorporating this Formula to produce a dispersed silica solution called Intermediate Product 4. A quantity of Intermediate Product 4 was subsequently processed with additional agents as shown in Table 4B as per the processes described herein to produce a stable aqueously dispersed superhydrophobic composition called Product Formulation 4.

TABLE 4A
Dispersion Process Formula 4

| Component | Mass (g) |
|---|---|
| Dynol 604 | 0.89 |
| BYK-346 | 2.68 |
| BYK-022 | 1.78 |
| Laponite RDS | 8.92 |
| Joncryl 77 | 2.68 |
| Tego Viscoplus 3010 | 1.78 |
| Tego Viscoplus 3030 | 1.78 |
| Disperbyk 190 | 0.36 |
| Aerosil R 208 | 5.35 |
| DPM Glycol Ether | 5.00 |
| Isopropyl Alcohol | 50.00 |
| Water | 418.79 |

In a 1-quart steel mixing pot, 134.99 g of water was combined with 0.21 g of BYK-022, 8.92 g of Laponite RDS, and 0.39 g of Dynol 604 and was mixed with an IKA RW-20 overhead stirrer affixed with a dispersing blade at a rate of 2500 rpm for 30 minutes. This thickened mixture was combined with 0.36 g of Disperbyk 190, 5.35 g of Acematt TS100, 2.68 g of Joncryl 77, 2.68 g of DSM NeoPac R-9045, 2.68 g of DSM NeoPac-9036, 1.78 g of Tego Viscoplus 3010, and 1.78 g of Tego Viscoplus 3030. This mixture was dispersed with the overhead stirrer operated at a rate of 2500 rpm for 30 minutes. This dispersion was then passed through a 1000 mL EMI Laboratory Mini Mill. The dispersed silica formula was let down with 188.60 g water while mixing with the overhead stirrer fitted with a propeller blade at 1500 rpm, and 2.68 g of BYK-346, 0.50 g of Dynol 604, 1.57 g of BYK-022, 5.00 g of DPM glycol ether, and 50 g of isopropyl alcohol were added before dilution with an additional 94.30 g of water. Intermediate Product 4 was obtained after stirring for an additional 60 minutes.

TABLE 4B
Product Formulation 4

| Component | Mass (g) |
|---|---|
| Intermediate Product 4 | 28.037 |
| Water | 61.847 |
| PnB Glycol Ether | 2.000 |
| DPM Glycol Ether | 0.720 |
| Isopropyl Alcohol | 2.196 |
| Tego Phobe 1650 | 5.000 |
| Dynasylan MTES | 0.200 |

In a 1-quart steel mixing pot stirred at a rate of 1500 rpm with an IKA RW-20 overhead stirrer fitted with a propeller blade, 28.037 g of the dispersed silica solution was combined with 59.85 g 61.847 of water, 2.00 g of PnB glycol ether, 0.72 g of DPM glycol ether, 2.20 g of isopropyl alcohol, 2.00 g of DPnB glycol ether, 5.00 g of Tego Phobe 1650, and 0.20 g of Dynasylan MTES. The pot was stirred for 30 minutes to obtain the stable aqueously dispersed superhydrophobic composition called Product Formulation 4.

### Example 5

This Exemplary embodiment describes one Product Formulation suited to treating fabrics and/or textiles to make them hydrophobic or superhydrophobic. Product Formulation 5 is prepared using the pre-gel forming, let-down, and final formulation methods described herein, and more specifically, as described in the preceding Examples. The preferred formula is forth in Table 5 below.

While the present invention is not limited to any particular mechanisms of action, and indeed, the invention is not so limited, it is contemplated that in preferred embodiments, such as that described in this Example, that the four aqueous dispersion components in the composition work together synergistically to provide complementary but different stain or water-resistant functionalities. In this embodiment, the components favorably comprise a reactive alkyl-urethane, a reactive silicone, a non-reactive silicone elastomer, and a nonreactive polymeric wax dispersion, wherein, the reactive alkyl-urethane (e.g., ZELAN® CA-72, Chemours Inc., Wilmington, Del.), creates durability and wash resistance. The reactive silicone, CoatOSil 2059 (Momentive Performance Materials Inc., Columbus, Ohio), also improves durability, penetrates textile and fabric fibers to reduce uptake of stains, and offers fast-forming water repellency. CoatOSil DRI is a silicone elastomer that forms a very thin coating on fibers to prevent penetration of stains into the substrate. Polymer wax dispersions, such as, Wükoseal 2800, improves the oleophobicity and fast-forming water repellency of the exemplary Product Formulation 5.

TABLE 5
Exemplary Product Formulation 5

| | RANGE | RANGE | RANGE | RANGE | RANGE | RANGE | |
|---|---|---|---|---|---|---|---|
| | UPPER | LOWER | A +/−100% OF | B +/−75% OF | C +/−50% OF | D +/−25% OF | |
| COMPONENT | LIMIT | LIMIT | OPTIMAL | OPTIMAL | OPTIMAL | OPTIMAL | OPTIMAL |
| Dynol 604 | 1.000% | 0.001% | 0.028%-0.001% | 0.0245%-0.0035% | 0.021%-0.007% | 0.0175%-0.0105% | 0.014% |
| BYK-022 | 1.000% | 0.010% | 0.096%-0.010% | 0.084%-0.012% | 0.072%-0.024% | 0.0576%-0.0384% | 0.048% |
| Optigel LX | 2.000% | 0.050% | 0.256%-0.050% | 0.224%-0.032% | 0.192%-0.064% | 0.160%-0.096% | 0.128% |
| Disperbyk 190 | 2.000% | 0.010% | 0.054%-0.010% | 0.0473%-0.0068% | 0.0405%-0.0135% | 0.0338%-0.0203% | 0.027% |
| Aerosil R 208 | 3.000% | 0.100% | 1.000%-0.100% | 0.875%-0.125% | 0.750%-0.250% | 0.625%-0.375% | 0.500% |
| Rheobyk-L | 3.000% | 0.100% | 0.390%-0.100% | 0.341%-0.0486% | 0.2925%-0.0975% | 0.243%-0.1463% | 0.195% |
| 1400 | | | | | | | |
| Rheobyk-H | 3.000% | 0.100% | 0.390%-0.100% | 0.341%-0.0486% | 0.2925%-0.0975% | 0.243%-0.1463% | 0.195% |
| 6500VF | | | | | | | |
| BYK-011 | 1.000% | 0.010% | 0.096%-0.010% | 0.084%-0.0120% | 0.072%-0.024% | 0.060%-0.036% | 0.048% |
| PnB Glycol | 5.000% | 1.000% | 5.000%-1.000% | 5.000%-0.750% | 4.500%-1.500% | 3.750%-2.250% | 3.000% |
| Ether | | | | | | | |
| DPM Glycol | 5.000% | 1.000% | 5.000%-1.000% | 5.000%-0.9392% | 5.000%-1.8785% | 4.6963%-2.8178% | 3.757% |
| Ether | | | | | | | |
| Water | 94.000% | 50.000% | | | | | 80.277% |
| Zelan CA-72 | 10.000% | 1.000% | 10.000%-1.000% | 8.750%-1.250% | 7.500%-2.500% | 6.250%-3.750% | 5.000% |
| CoatOSil 2059 | 10.000% | 1.000% | 7.000%-1.000% | 6.125%-1.000% | 5.250%-1.750% | 4.375%-2.625% | 3.500% |
| CoatOSil DRI | 10.000% | 1.000% | 3.422%-1.000% | 2.994%-1.000% | 2.567%-1.000% | 2.1386%-1.2833% | 1.711% |
| Wükoseal 2800 | 10.000% | 1.000% | 3.200%-1.000% | 2.800%-1.000% | 2.400%-1.000% | 2.000%-1.200% | 1.600% |

### Example 6

### Selection Criteria for Fabrics in Multilayered Cotton Fabric Face Masks

Briefly three main parameters were used to select woven fabrics for further testing I the manufacture of multilayered fabric PPE face masks: 1) the degree of efficacy of superhydrophobic composition treatments optimized for air drying and/or optimized for heat curing on the fabric substrate; 2) the availability of the fabric substrate and the similarity of the fabric substrate to those already widely used by the public to make face masks; and 3) the aerosolized droplet filtration efficacy of the fabric substrate as measured using the testing methodology described in S. R. Lustig et al. (Lustig S. R., et al., “Effectiveness of Common Fabrics to Block Aqueous Aerosols of Virus-like Nanoparticles,” Amer. Chem Soc. Nano, vol. 14, pp. 7651-7658 (2020)). Based on the above parameters and consideration of relevant testing methodologies described in Lustig et al., the following woven multilayer fabric face mask candidates described in Table 6 were advanced for further testing with superhydrophobic composition treatments.

TABLE 6
Multilayered Cotton Fabric Face Masks

| Layer 1 (outermost) | Layer 2 | Layer 3 (innermost) |
|---|---|---|
| Kona Cotton, treated | Kona Cotton | None |
| Kona Cotton | Kona Cotton, treated | Kona Cotton |
| Heavy Cotton T-shirt | Kona Cotton, treated | Heavy Cotton T-shirt |
| Kona Cotton treated | Kona Cotton | Kona Cotton |
| Kona Cotton treated | Heavy Cotton T-shirt | Heavy Cotton T-shirt |

All fabrics were supplied by Robert Kaufman Co., Inc., Monroe, Conn., US. Multilayered face mask test articles were constructed using directions provided at:
https://www.joann.com/how-to- make-a-denim-face-mask/042188731P326.html.

### Example 7

### Application of Superhydrophobic Coatings to Multilayered Cotton Fabric Face Masks

All fabric treatments were prepared onsite using fabric combinations described in Example 6. Test face mask articles received either: 1) an air dried superhydrophobic composition (“DP-AD”); treatment 2) a heat cured superhydrophobic composition (“DP-HD”) treatment; or 3) no superhydrophobic composition treatment in order to provide controls.

Briefly, face mask test articles that received a DP-AD treatment received two heavy aerosolized coats of DP-AD followed by a 72-hour drying period. Face mask test articles that received a DP-HD treatment were dip-coated, wrung out using a manual-crank clothes wringer, and heated in a gravity convection oven at 180° C. for 15 minutes.

Each of the five fabric layer combinations was tested with both DP-AD treatment and DP-HC treatment. Additionally, control tests were performed on untreated fabric to complement the existing untreated tests. The face mask test articles are outlined in Table 7.

TABLE 7
Multilayered Cotton Fabric Face Mask Testing Scheme

| Test # | Layer 1 (outermost) | Layer 2 | Layer 3 (innermost) |
|---|---|---|---|
| 1A | DP-AD Kona Cotton | Kona Cotton | — |
| 1B | DP-HC Kona Cotton | Kona Cotton | — |
| 2A | Heavy Cotton T-shirt | DP-AD Kona Cotton | Heavy Cotton T-shirt |
| 2B | Kona Cotton | DP-AD Kona Cotton | Kona Cotton |
| 2C | Heavy Cotton T-shirt | DP-HC Kona Cotton | Heavy Cotton T-shirt |
| 2D | Kona Cotton | DP-HC Kona Cotton | Kona Cotton |
| 2E | Heavy Cotton T-shirt | Kona Cotton | Heavy Cotton T-shirt |
| 3A | DP-AD Kona Cotton | Heavy Cotton T-shirt | Heavy Cotton T-shirt |
| 3B | DP-AD Kona Cotton | Kona Cotton | Kona Cotton |
| 3C | DP-HC Kona Cotton | Heavy Cotton T-shirt | Heavy Cotton T-shirt |
| 3D | DP-HC Kona Cotton | Kona Cotton | Kona Cotton |
| 3E | Kona Cotton | Heavy Cotton T-shirt | Heavy Cotton T-shirt |

### Example 8

### General Testing Protocols for Face Mask Test Articles

The Face mask test articles were tested according to the general methods and protocols described in S. R. Lustig et al. (Lustig S. R., et al., “Effectiveness of Common Fabrics to Block Aqueous Aerosols of Virus-like Nanoparticles,” Amer. Chem Soc. Nano, vol. 14, pp. 7651-7658 (2020)).
A) Virus-Simulant Nanoparticles Materials

Ethyl acetate, poly- (lactic-co-glycolic acid) (PLGA), eicosane, rhodamine 6G, and poly(vinyl alcohol) (PVA) were purchased from Sigma-Aldrich (Billerica, Mass., USA) and were used as-is without any further processing or purification.

1) PLGA Nanoparticle Preparation

Nanoparticles (NPs) were prepared by mixing 100 mg of PLGA pellets with 1 mL of ethyl acetate, 20 μg of rhodamine 6G, and 12 mg of eicosane. The resulting mixture was vortexed for 5-10 min until homogenized. Two mL of 5 wt % PVA was added and sonicated for 2 min using an ice water bath to prevent evaporation of ethyl acetate. This solution was mixed with 50 mL of 3 wt % PVA solution immediately after sonication and stirred at 800 rpm for 2 h until the ethyl acetate evaporated. The resulting solution was split into two centrifuge tubes and centrifuged at 6,000 rpm for 5 min followed by the removal of the supernatant. The remaining precipitate was diluted with deionized water and vortexed for another 5 min. The centrifugation and rinse were repeated three times. The final precipitate was diluted with 30 mL of water to obtain a final experimental concentration of ca. 7 mg/mL. A small aliquot of dispersion was weighed both wet and dry to determine accurately the actual NP concentration. This stock solution was further diluted to 0.5 mg/mL for experimentation. This concentration was chosen after a series of experiments to determine optimal NP concentration such that NPs do not aggregate, did not clog the fabrics, and did not clog the aerosol generator.

2) PLGA NP Size Distribution and Zeta Potential Tests

NP size distribution and zeta potential tests were conducted using a Malvern Zetasizer Nano ZS90 and the accompanying Malvern Zetasizer v7.12 software. Polystyrol/ polystyrene (D-51588) cuvettes from Sarstedt were used for sample loading and measurements. The stock solution concentration of NPs of 7.0 mg/mL (or 1×) was serially diluted to achieve 10×, 50×, 100×, 200×, 400×, 800×, 1,600×, 3,200×, 6,400×, 12,800×, 25,600×, and 51,200× dilution factors. Exactly 1 mL of the diluted solutions was loaded into a cuvette and placed within the Zetasizer instrument. For each dilution, three samples were prepared, and three measurements were taken per sample (n=9) using a 173° backscatter measurement angle. The Zetasizer was configured for size measurements using PLGA@eicosane with a refractive index of 1.570 and absorption value of 0.001 with a dispersant of water at 25° C. For NP size measurements, no other settings were required, whereas for zeta potential measurements, a Smoluchowski model is applied with an F(Kα)=1.50, where K is the Debye length and α is the radius of the particle. The NP size distribution and zeta potential were then plotted using Graphpad Prism v8.0.0.

### B) Aerosol Transmission Testing and Testing Apparatus

A test apparatus was designed to analyze the degree of transmission of aerosols through various materials. Design parameters for this system were informed by ASTM procedures that involve testing the performance of surgical masks in filtering aerosols. (See, ASTM International, ASTM F2100-19, Standard Specification for Performance of Materials Used in Medical Face Masks (2019); ASTM International, ASTM F2101-19, Standard Test Method for Evaluating the Bacterial Filtration Efficiency (BFE) of Medical Face Mask Materials, Using a Biological Aerosol of Staphylococcus aureus (2019); and ASTM International, ASTM F2299M-03, Standard Test Method for Determining the Initial Efficiency of Materials Used in Medical Face Masks to Penetration by Particulates Using Latex Spheres, DOI: 10.1520/F2299_F2299M-03R17 (2017)). The Master Airbrush Pro Gravity Feed Airbrushing System ECO KIT-17 is used to generate an aerosol containing the fluorescent nanoparticle solution. A Master TC-20 air compressor pressurizes the solution to 20 kPa. The pressurized solution is emitted from the Master airbrush G22 as an aerosol due to shearing interactions at the airbrush tip with an opening diameter of 345 μm. For each trial, 2 mL of nanoparticle solution is emitted from the airbrush in bursts with a duration of one second every five seconds until the airbrush fluid tank is depleted. The aerosol is released into a 1 L vacuum filter reservoir sealed over a glass bottle during a steady-state 14 L/min volumetric flow of air set using a Sho-Rate rotameter #012. The vacuum filter is sealed so that the volumetric flow rate is approximately uniform within the test apparatus, and it is controlled so that the contained fluids exhibit laminar flow (Re=1900<2000). The velocity of the aerosol at the nozzle facing the material samples is estimated to be 297 cm/s. For each material, a 30 mm diameter sample is cut and held tightly with an O-ring over a nozzle with an inner diameter of 10 mm. The material samples are held taut, and all samples consisting of layered materials are necessarily held without spacing between adjacent layers. An 0.5 in.×0.5 in. glass slide is positioned 1 mm from the material sample to collect aerosol and droplets that are transmitted. A circle drawn on the opposite face of the glass slide indicates the position of the slide that aligns with the center of the material sample, and the aerosol that accumulates on the side facing the sample is analyzed using fluorescence microscopy.
C) Aerosol Droplet Size Distribution

Droplet size distribution was determined by using the spray apparatus and spraying directly onto a 0.5 in.×0.5 in. glass slide. The spray collected from one aerosol burst was then evaluated under a Keyence VHX-970F optical microscope from Keyence Corp. (Keyence Corp., Itasca, Ill., USA). Images were captured at 20× magnification for large droplets and aerosols and 100× magnification for all droplets to understand the full droplet size distributions. A total of 64 images were taken. The raw images were further processed using ImageJ26 to subtract the background with a 50 pixel rolling ball radius and a dark background. A scale of 26 pixels was identified as the equivalent of 10 μm. The images were also cropped from the bottom by 50 pixels to remove the magnification and scale bar texts to remove any erroneous particles being counted due to the text. The image was then converted to an 8-bit image format to which a minimum and maximum contrast threshold was set to 0 and 225, respectively. This resulted in black (droplets) and white (background) images. The procedure was automated by creating a custom Plugin using ImageJ's batch scripting language, to remove human bias during image analysis and to speed up analysis. The veracity of the script was confirmed by manual analysis of each step, per the image output examples. The size distribution and frequency were then plotted using Graphpad Prism v8.0.0.
D) Nanoparticle Distribution after Transmission through Fabrics

Nanoparticle distribution was measured by placing 1 cm×1 cm glass slides onto the glass holder within the test apparatus and sprayed with fluorescent rhodamine tagged PLGA NPs. The NP-containing glass slides were then observed under an Olympus BX43 fluorescent microscope, containing an Olympus U-TV1XC center and Olympus XM10 camera. An X-CITE 120 LED Boost laser controller from Excelitas Technology was used for a fluorescent laser source run at 45% power for fluorophore excitation. (Excelitas Technologies Corp., Waltham, Mass., USA). At least nine images were taken at 20× optical zoom per fabric to determine particle concentration per area, and multiple experiments were conducted per fabric using the accompanying Olympus cellSense Standard 1.16 software. (Olympus Corp., Center Valley, Pa., USA). A constant gain and exposure were chosen of 18 dB and 1.109s, respectively, and a fixed scale contrast was applied between 0 and 5000. Individual images were postprocessed in ImageJ, similar to the droplet size distribution protocol. The raw images were further processed using ImageJ to subtract the background with a 500-pixel rolling ball radius and a dark background. A scale of 160 pixels was identified as the equivalent of 50 μm. The images were cropped from the bottom by 50 pixels to remove the magnification and scale bar texts to remove any erroneous particles being counted due to the text. The image was then converted to an 8-bit image format to which a minimum and maximum contrast threshold was set to 15 and 250, respectively. This resulted in black (droplets) and white (background) images. These black and white images were then counted and measured via the ImageJ counting feature, within the Analyze feature, using an ellipse outline method. The ellipses were counted, and the diameter is measured to obtain the total distribution of droplets by size and frequency. The procedure was automated by creating a custom Plugin using ImageJ batch scripting language, to remove human bias during image analysis and to exponentially speed up analysis. The veracity of the script was confirmed by manual analysis of each step.

### Example 9

### Results From test and Analysis in Example 8

The results of the testing conducted according to the methodologies of Example 8 are shown in Table 8.

TABLE 8
Results Shown with Error and p-values For all Multilayered Face Mask Test Articles

| | | | N95- |
|---|---|---|---|
| | | | Normalized |
| | | | Fractional |
| Test | | Fractional | Transmission |
| Number | Test | Transmission | (p-value) |
| 1A | DP-AD Kona Cotton, Kona Cotton | 0.62 ± 0.02 | 1.1 (0.156) |
| 1B | DP-HC Kona Cotton, Kona Cotton | 0.58 ± 0.01 | 1.0 (0.601) |
| 2A | Heavy Cotton Tee, DP-AD Kona | 0.59 ± 0.02 | 1.0 (0.511) |
| | Cotton, Heavy Cotton Tee | | |
| 2B | Kona Cotton, DP-AD Kona Cotton, | 0.55 ± 0.03 | 1.0 (0.601) |
| | Kona Cotton | | |
| 2C | Heavy Cotton Tee, DP-HC Kona | 0.56 ± 0.01 | 1.0 (0.939) |
| | Cotton, Heavy Cotton Tee | | |
| 2D | Kona Cotton, DP-HC Kona Cotton, | 0.52 ± 0.01 | 0.9 (0.266) |
| | Kona Cotton | | |
| 2E | Heavy Cotton Tee, Kona Cotton, | 0.70 ± 0.03 | 1.3 (0.001) |
| | Heavy Cotton Tee | | |
| 3A | DP-AD Kona Cotton, Heavy Cotton | 0.54 ± 0.10 | 1.0 (0.624) |
| | Tee, Heavy Cotton Tee | | |
| 3B | DP-AD Kona Cotton, Kona Cotton, | 0.76 ± 0.07 | 1.4 (0.001) |
| | Kona Cotton | | |
| 3C | DP-HC Kona Cotton, Heavy Cotton | 0.50 ± 0.12 | 0.9 (0.134) |
| | Tee, Heavy Cotton Tee | | |
| 3D | DP-HC Kona Cotton, Kona Cotton, | 0.66 ± 0.03 | 1.2 (0.010) |
| | Kona Cotton | | |
| 3E | Kona Cotton, Heavy Cotton Tee, | 0.65 ± 0.01 | 1.2 (0.014) |
| | Heavy Cotton Tee | | |

Both two-layer Kona cotton samples treated with superhydrophobic composition showed significantly decreased fractional transmission rates with respect to the untreated 2-layer Kona cotton sample. FIG. 2 shows a 32.61% decrease in total fractional transmission between DP-AD Kona cotton, and a 36.96% total decrease in fractional transmission rate for DP-HC Kona cotton. The 6.45% improvement between DP-HC and DP-AD treatments on Kona cotton was statistically significant. The published result for a 5-layer N95 respirator is shown as a line on FIG. 2. The fractional transmission rate performance of DP-HC and DP-AD Kona cotton was statistically equivalent to the measured value for the N95 respirator. Additionally, DP-HC Kona cotton samples showed a lower fractional transmission rate than DP-AD Kona cotton samples.

FIG. 3 shows the test results for tests 2A-2E, as well as the Kona cotton×3 test published by Lustig et al. (Lustig S. R., et al., “Effectiveness of Common Fabrics to Block Aqueous Aerosols of Virus-like Nanoparticles,” Amer. Chem Soc. Nano, vol. 14, pp. 7651-7658 (2020)). In all DP-AD and DP-HC samples the difference in transmission rates was effectively eliminated. All treated samples improved with respect to their untreated counterpart and had fractional transmission rates statistically equivalent to an N95 respirator.

A comparison between tests from group 2 and group 3 was made to determine if there was a difference in efficacy when treating the middle layer or outer layer of a 3-layer mask. Samples 2A, 3A, 2C, and 3C showed no statistical improvement in fractional transmission rate between their respective equivalents. Meanwhile tests 2B, 3B, 2D, and 3D showed large increase in fractional transmission rate was observed in Kona cotton x 3 in samples with the outer layer treated versus samples with inner layer treated. While the present invention is not limited to any particular mechanism, it is contemplated that this does not represent a meaningful difference in fractional transmission rate, but a result caused by the test setup, as it had been observed in previous experiments that in multilayer masks with adjacent layers of Kona cotton the fractional transmission rate was consistently higher than expected and was likely a result of tension in the fabric from the sample holder causing an increase in pore size in the Kona cotton weave.

Modifications and variations of the present invention will be obvious to those skilled in the art from the foregoing detailed description of the invention. Such modifications and variations are intended to come within the scope of the appended claims.

### INCORPORATION BY REFERENCE

All U.S. and foreign Patent Publications, Patent Applications, and Patents are hereby expressly and specifically incorporated by reference in their entireties.

What is claimed:

1. A composition comprising a single layered woven fabric face mask comprising a stable aqueously dispersed hydrophobic suspension composition comprising an aqueously-stabilized amorphous silica and one or more additional components.

2. A composition comprising a double layered woven fabric face mask comprising a stable aqueously dispersed hydrophobic suspension composition comprising an aqueously-stabilized amorphous silica and one or more additional components.

3. A composition comprising a triple layered woven fabric face mask comprising a stable aqueously dispersed hydrophobic suspension composition comprising an aqueously-stabilized amorphous silica and one or more additional components.

4. A composition comprising from one to five layers of woven fabric face comprising a stable aqueously dispersed hydrophobic suspension composition comprising an aqueously-stabilized amorphous silica and one or more additional components.

5. A composition comprising a multilayered woven fabric face mask system comprising a stable aqueously dispersed hydrophobic suspension composition comprising an aqueously-stabilized amorphous silica and one or more additional components.

6. A composition comprising a multilayered woven fabric face mask system wherein, one fabric surface comprises a stable aqueously dispersed hydrophobic suspension composition comprising an aqueously-stabilized amorphous silica and one or more additional components.

7. A composition comprising a multilayered woven fabric face mask system wherein, at least one fabric surface comprises a stable aqueously dispersed hydrophobic suspension composition comprising an aqueously-stabilized amorphous silica and one or more additional components.

8. A composition comprising a multilayered woven fabric face mask system wherein, one fabric surface is treated with an air dried stable aqueously dispersed hydrophobic suspension composition comprising an aqueously-stabilized amorphous silica and one or more additional components.

9. A composition comprising a multilayered woven fabric face mask system wherein, one fabric surface is treated with a heat cured stable aqueously dispersed hydrophobic suspension composition comprising an aqueously-stabilized amorphous silica and one or more additional components.

10. A composition according to claims 1-9, wherein said stable aqueously dispersed hydrophobic suspension is substantially free of perfluoroalkyl compounds.

11. A composition as disclosed herein.

12. A method as disclosed herein.
